(19) United States
(12) Patent Application Publication
(10) Pub. No.: US 2009/0144264 A1
(43) Pub. Date: Jun. 4, 2009

(54) THIRD-PARTY INFORMATION OVERLAY ON SEARCH RESULTS

(76) Inventors: Vik Singh, San Jose, CA (US); Eckart Walther, Palo Alto, CA (US); Jeff Bonforte, San Francisco, CA (US); Amit Kumar, San Jose, CA (US); Tom (Liang-Yu) Chi, San Francisco, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/950,398

(22) Filed: Dec. 4, 2007

(51) Int. Cl. G06F 17/30

(52) U.S. Cl. 707/5; 707/E17.108

(57) ABSTRACT

Embodiments of the present invention provide systems and methods for integrating third-party information, such as third-party rating information, over the search results. The integrated third-party information in search results provides users additional information to determine which search results to click on for more details. In one embodiment, the methods and systems allow users to choose which third-party data sources to include (or overlay) in their search results. Whenever a user issues a search request to a search engine, which returns search results that correspond to relevant third-party overlay data, the search engine will return a list of the search results integrated with the corresponded third-party data. The integrated third-party information augments the titles, abstracts and link descriptions of search results to help the user determine which search results in the list are relevant. The information, such as rating and review information, provided by third parties trusted by the user can also help the user judge the quality of products and services described in the search results.

### BACKGROUND OF THE INVENTION

1. Field of the Invention

The present invention relates to displaying search results to users, and more particularly relates to methods and systems for overlaying third-party information on displayed search results.

2. Description of the Related Art

A search engine is a search application capable of receiving a search term (e.g., “restaurant,” “beauty supplies,” etc.) from a network user and providing the user, in response thereto, with a search result list containing information (or hyperlinks to information) theoretically relevant to the search term. Traditional search applications locate relevant information by using an automated crawling application (e.g., a “web crawler”) to index information available to users of the Internet, and a relevancy algorithm to determine which indexed information is relevant. The information available to users of the Internet includes, but not limited to, web pages, news groups, databases, open directories, images, videos, audios, and other types of files.

The search engine may return a summary of the identified content in the form of a set of search results to the client system. The search results might include titles, abstracts, and/or links for the identified pieces of content. The search query and search results may be routed between the client system and the search engine over one or more networks, and by one or more servers coupled to the network. In many cases, the search results comprise many more hits (or results) than the querier can contemplate; therefore, only the first few hits (or results) displayed might be examined.

As mentioned above, the search results might include titles, abstracts, and/or links for the identified pieces of content. A user clicks a particular search result to view detailed contents of the search results based on several factors, including confidence in relevancy of the search results based on previous search experience with the search engine, the description of the hyperlinks matching the user's interests, and the relevancy of the brief abstract typically appearing below the hyperlink of each search result. Providing displayed search results with information to help users decide whether the search results are relevant and/or are worth taking further action, such as clicking on the links, helps users get to the needed information with the least amount of effort in trial and error.

It is in this context that embodiments of the present invention arise.

### SUMMARY OF THE INVENTION

Broadly speaking, the embodiments of the present invention provide systems and methods for integrating third-party information, such as third-party rating information, over the search results. The integrated third-party information in search results provides users additional information to determine which search results to click on for more details. In one embodiment, the methods and systems allow users to choose which third-party data sources to include (or overlay) in their search results. Whenever a user issues a search request to a search engine, which returns search results that correspond to relevant third-party overlay data, the search engine will return a list of the search results integrated with the corresponded third-party data. The integrated third-party information augments the titles, abstracts and link descriptions of search results to help the user determine which search results in the list are relevant. The information, such as rating and review information, provided by third parties trusted by the user can also help the user judge the quality of products and services described in the search results.

It should be appreciated that the present invention can be implemented in numerous ways, including as a method, a system, or a device. Several inventive embodiments of the present invention are described below.

In one embodiment, a method of returning search results overlayed with third-party rating information by a search engine is provided. The method includes configuring the search engine to include rating information provided by a plurality of third parties to be integrated with the search results. The method also includes receiving a search request from a user. The method further includes returning search results related to the search request. The search results are overlayed with rating information relevant to the search results and the rating information being provided by the plurality of third parties. The rating information being overlayed provides the user additional information about the search results to help the user determine the relevancy of the search results.

In another embodiment, an information retrieval system for searching information stored on a plurality of information server systems connected to the Internet and to return search results with integrated rating information is provided. The information retrieval system includes the plurality of information server systems storing information to be retrieved by users, wherein the information servers are connected to the Internet. The information retrieval system also includes a search system. The search system is connected to the Internet and indexes contents on the plurality of information server systems. The search system receives a search request from a user and returns the search results related to the search request to the user. The information retrieval system further includes a plurality of third-party rating server systems connected to the Internet. The plurality of third-party rating server systems provide rating information on some of the information stored on the plurality of information server systems. The rating information is provided to the search system and the rating information being integrated in the search results presented to the user to provide the user additional information about the search results.

In yet another embodiment, computer readable media including program instructions for returning search results overlayed with third-party rating information by a search engine is provided. The computer readable media include program instructions for configuring the search engine to include rating information provided by a plurality of third parties to be integrated with the search results. The computer readable media also include program instructions for receiving a search request from a user. The computer readable media further include program instructions for returning search results related to the search request. The search results are overlayed with rating information relevant to the search results and the rating information being provided by the plurality of third parties. The rating information being overlayed provides the user additional information about the search results to help the user determine the relevancy of the search results.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows an illustration of an information retrieval system operating over the Internet, in accordance with one embodiment of the present invention.

FIG. 2A shows a diagram illustrating a search system operating over the Internet, in accordance with one embodiment of the present invention.

FIG. 2B shows a page of search results returned by a search system after the search term of “san francisco fusion food” is entered, in accordance with one embodiment of the present invention.

FIG. 2C shows a web page of a search result, in accordance with one embodiment of the present invention.

FIG. 2D shows a page of search results integrating with rating information, in accordance with one embodiment of the present invention.

FIG. 2E shows a diagram of an information retrieval system configured to provide third-party ratings in the information retrieved, in accordance with one embodiment of the present invention.

FIG. 3A shows codes of rating information provided by a third party, in accordance with one embodiment of the present invention.

FIG. 3B shows a code for an application programming interface (API) of how a developer can generate dynamic annotations, in accordance with one embodiment of the present invention.

FIG. 3C show a web page being viewed by an administrator, Administrator 1, in accordance with one embodiment of the present invention.

FIG. 3D show a window opened after the “bookmark” button has been pushed, in accordance with one embodiment of the present invention.

FIG. 4A shows a diagram illustrating a search system operating over the Internet and a search window on a client computer of an USER-1, in accordance with one embodiment of the present invention.

FIG. 4B shows a web page for USER-1 to select third parties for rating information overlay in search results of USER-1, in accordance with one embodiment of the present invention.

FIG. 4C shows a process flow of a user conducting a search on a search engine, in accordance with one embodiment of the present invention.

FIG. 4D shows a process flow of a search engine for integrating third-party ratings in the search results, in accordance with one embodiment of the present information.

FIG. 5A illustrates a web page of Third-Party 1 that offers rating service, in accordance with one embodiment of the present invention.

FIG. 5B shows the code that a search engine company offers to Third-Party 1 to include in the web page code to create a search box, in accordance with one embodiment of the present invention.

FIG. 5C show a web page of Third-Party 1 with an information window including a search box, in accordance with one embodiment of the present invention.

FIG. 5D shows a search result page for the user that enters “Hotel in Park City, Utah”, in accordance with one embodiment of the present invention.

### DETAILED DESCRIPTION

Embodiments of the invention will now be described, by way of example, not limitation. It is to be understood that the invention is of broad utility and may be used in many different contexts.

Broadly speaking, the embodiments of the present invention provide systems and methods for integrating third-party information, such as third-party rating information, over the search results. The integrated third-party information in search results provides users additional information to determine which search results to click on for more details. In one embodiment, the methods and systems allow users to choose which third-party data sources to include (or overlay) in their search results. Whenever a user issues a search request to a search engine, which returns search results that correspond to relevant third-party overlay data, the search engine will return a list of the search results integrated with the corresponded third-party data. The integrated third-party information augments the titles, abstracts and link descriptions of search results to help the user determine which search results in the list are relevant. The information, such as rating and review information, provided by third parties trusted by the user can also help the user judge the quality of products and services described in the search results.

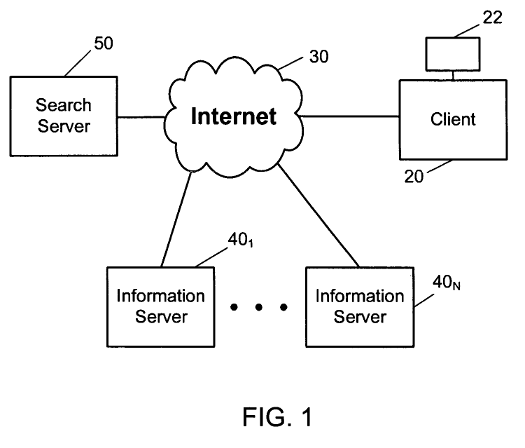

FIG. 1 shows an illustration of an information retrieval system (or search system) 10 including a client system 20 according to an embodiment of the present invention. In information retrieval system 10, client system 20 is coupled through an Internet 30, to a search server (or information retrieval server) 50 and any number of information servers (or information server systems) 40₁ to 40_{N}. Client system 20 is configured to communicate with the search server 50 and any of information servers 40₁ to 40_{N}, for example, to request, access, receive, retrieve, and/or display a set of search results. As referred to herein a set includes one or more elements. The search server 50 is configured to communicate with the client system 20 to receive search quest and to return search results to the client system 20. In addition, search server 50 is configured to index contents in information servers (or information server systems) 40₁ to 40_{N}.

Several elements in the system shown in FIG. 1 include conventional, well-known elements that need not be explained in detail here. For example, client system 20 might include a desktop personal computer, workstation, laptop, PDA (personal digital assistant), cell phone, any wireless application protocol (WAP) enabled device or any other computing device capable of interfacing directly or indirectly to the Internet. Client system 20 typically runs a browser program, such as Microsoft's Internet Explorer™ browser, Netscape Navigator™ browser, Mozilla™ browser, Opera™ browser, a WAP-enabled browser in the case of a cell phone, a PDA or other wireless device, allowing a user of client system 20 to access, process and view search results available to it from information servers 40₁ to 40_{N} over Internet 30. Client system 20 might also include one or more user interface devices 22, such as a keyboard, a mouse, a roller ball, a touch screen, a pen or the like, for interacting with a graphical user interface (GUI) provided by the browser on a display (e.g., monitor screen, LCD display, etc.), in conjunction with pages, forms, and other information provided by information servers 40₁ to 40_{N}.

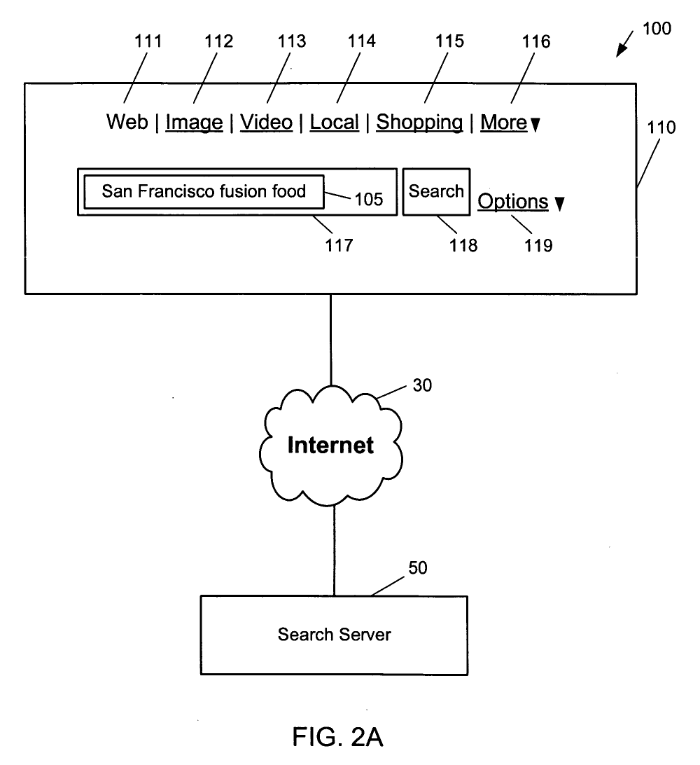

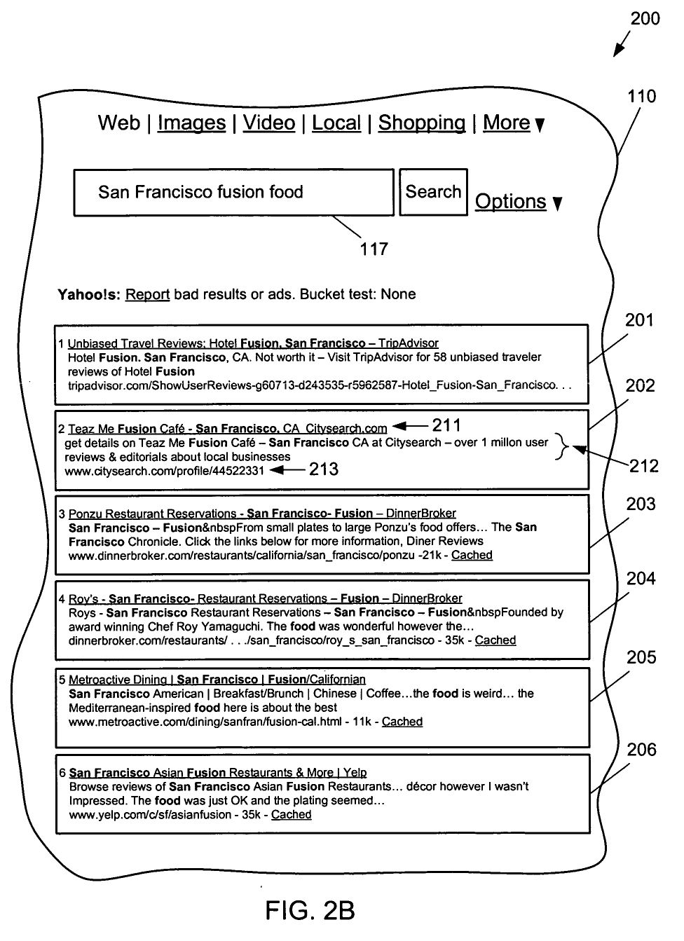

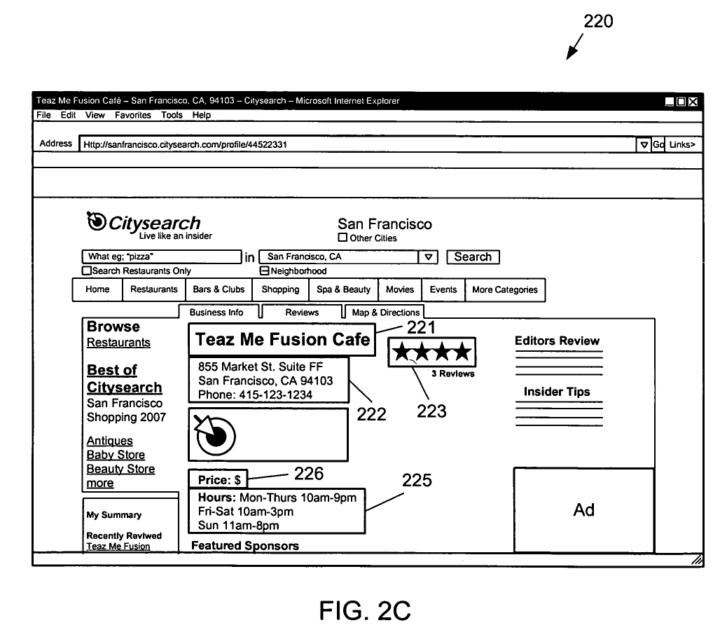

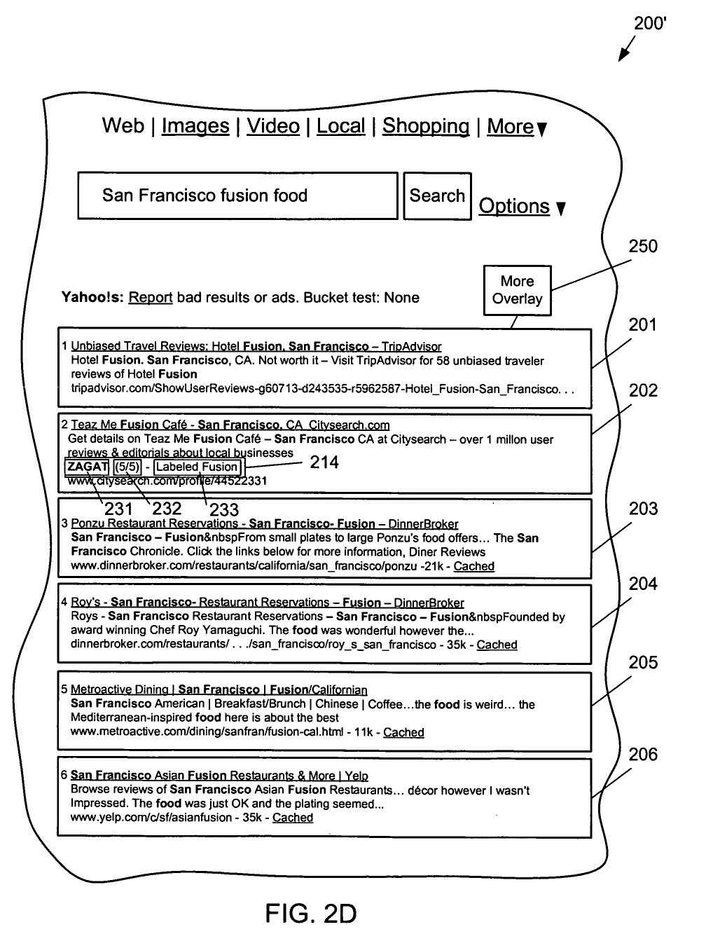

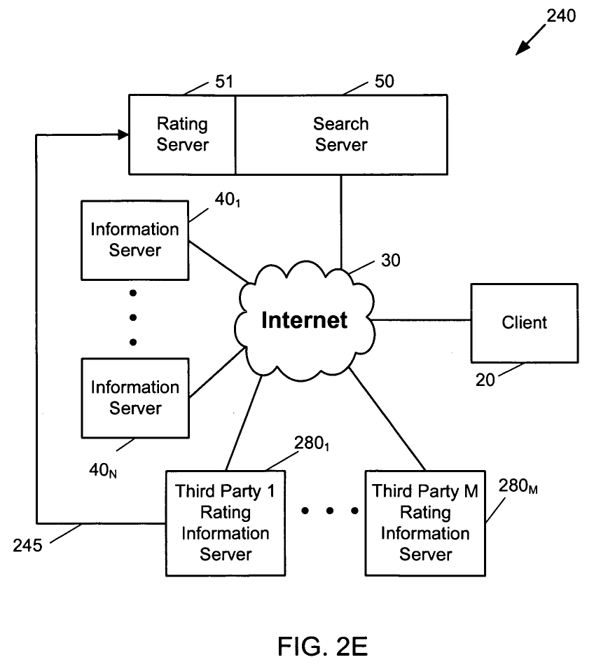

FIG. 2A shows a diagram illustrating a search system 100 operating over the Internet 30, in accordance with one embodiment of the present invention. A search client creates a search window 110 on a client computer of a user. The search window 110 is a graphical user interface. A search server 50 is also connected to the Internet 30 to interact with the search window 10 of the user. In one embodiment, the search window 110 includes a search box 117, where the user can enter a search term 105, or search key words, such as “san francisco fusion food”. Next to the search box 117, there is a “search button” 118, which the user can push to start the search process. In addition to the search box 117 and search button 118, there is a list of search choices above the search box 117. The list includes links to web 111, image 112, video 113, local 114, shopping 115, and more 116. The user can choose one of items from the list to determine which category to search. For example, the default search is web 111. When the user pushes the search button 118 after entering the search term 105, such as “san francisco fusion food,” the search engine 120 finds relevant web information in the web page indexes of the search engine. Alternatively instead of searching web pages, by clicking on the link web 111, the user can click on other links, such as the link to image 112, and enters a search term, such as “pig” in the search box 117. When the user enter the search term “pig” and selects “image” search, the search engine 120 finds images tagged with “pig” or having description of “pig”, and returns images related to “pig” to the users. The link to more 116 can include more search categories, such as jobs, audio, directory, and news, for the user to choose. In one embodiment, in the search window 110 and next to the search button 118, there is an “option” button 119. When the user clicks on the option button 119, other options of search, such as advanced search, appears. Links or buttons 111, 112, 113, 114, 115, 116, and 119 are optional.

FIG. 2B shows a search results page 200 returned by the search server 50 of FIG. 2A after the search term 150 of “san francisco fusion food” is entered to search the web, in accordance with one embodiment of the present invention. The search results page 200 includes the search window 110 with the search term 150 of “san francisco fusion food” in the search box 117, which is described above for FIG. 2A. The user can enter a new search term 150 in the search box 117 to enter a new search. Below the search window 107, there are a list of search results returned by the search server 50 of FIG. 2A. In FIG. 2B, six exemplary search results, 201, 202, 203, 204, 205, and 206, are shown. At the bottom of the search page 200, there are buttons to click for additional pages of search results (not shown). In one embodiment, a search result, such as search result 202, includes a link with title, such as link with title 211. The “link with title” has a title, or a brief description, that briefly describes the subject of the web page connected by the link. For example, link with title 211 of FIG. 2B shows “Teaz Me Fusion Cafe—San Francisco, Calif.: Citysearch.com.” When the user clicks on the link with title 211, a result web page 220, as shown in FIG. 2C, appears on the user's computer screen. The result web page 220 shows a web page of “Teaz Me Fusion Cafe” composed by Citysearch. The web page in the result window 220 of “Teaz Me Fusion Cafe” provides the user information about the restaurant, such as: title of the restaurant 221, address of the restaurant 222, a rating of the restaurant by Citysearch 223 (3.5 out of 5 stars in the example), a price range evaluation by Citysearch 224 (represented by one “$” sign in this example), and the operation hours 225 below the price range evaluation. Additional information related to the restaurant, such as “Reviews” and “Map and Directions”, and Citysearch is available on the result web page 220 or is available when the user clicks on the links on the result web page 220.

Below the link with title 211, there is an abstract 212 of the result web page 220, which would appear when the user click on the link with title 211, as shown in FIG. 2B. Abstract 212 provides more information related to the result web page 220 that is not described by the title description of the link with title 211 due to the limited length available for the link with title 211. For example, abstract 212 tells the user that the user can get details on “Teaz Me Fusion Café” in San Francisco at Citysearch site, which has over 1 million user reviews and editorials about local businesses. Below the abstract 212 of FIG. 2B is the web address 213, which is “www.citysearch.com/profile/44522331”, of the result web page 220.

As mentioned above, a list of search results, such as 201, 202, 203, 204, 205, and 206, appears in the search result page 200. The user, who enters the search term earlier, looks at the list of search results and decides which search result to click to get more detailed information. The user might have conducted the search to find a restaurant reserving “fusion food” in San Francisco to dine during the upcoming weekend. On a first glance of the search results, 201, 202, 203, 204, 205, and 206, search result 201 does not appear to be related to fusion food. It's selected because “Hotel Fusion” has a word “Fusion” and the hotel is in San Francisco. The user can find that the other 5 search results, 202, 203, 204, 205, and 206, all appear to be relevant to the “fusion food” that the user is looking for in San Francisco. The user can choose one of the search results to click for more details based on the user's prior knowledge of the restaurants, the web sites, such as “Citysearch”, that provide reviews of restaurants. If the user does not have prior knowledge of the listed restaurants or the restaurant review sites, the user will likely randomly click on one of the search results to view details until at least one restaurant serving fusion food in San Francisco appeals to the user. This is particular true for users new to San Francisco, not familiar with a restaurant in San Francisco, or a visitor to San Francisco.

For users who do not have sufficient knowledge of the subjects being searched, such as restaurants serving fusion food in San Francisco, it would be beneficial to have additional information provided by third parties trusted by the users, or by third parties known by the users. For example, ZAGAT™ survey is well known for providing ratings and reviews for restaurants. ZAGAT survey rates restaurants in major cities in the United States and around the world. Many users trust the ZAGAT survey rating and like to dine in restaurants with good ZAGAT survey ratings. When a user with such a background makes the search query mentioned in FIG. 2A, and when the user is not familiar with restaurants serving fusion food in San Francisco, the user would be more inclined to click on search results with ZAGAT survey ratings that suit that user.

FIG. 2D shows a search results page 200′ returned by the search engine 120 after the search term 150 of “san francisco fusion food” is entered to search the web, in accordance with another embodiment of the present invention. Everything in the search results page 200′ is the same as the search results page 200 of FIG. 2B, except search to result 202′. Search result 202′ is different from search result 202 by having an additional ZAGAT survey rating 214. The ZAGAT survey rating 214 includes an image 231 of “ZAGAT”, a rating 232 of “(5/5)”, and a brief description 233 provided by ZAGAT survey. When a user with a profile described in the last paragraph sees the search results page 200′, the user would likely appreciate the additional ZAGAT survey information provided in search result 202′. Since ZAGAT survey gives the restaurant a 5/5 rating, the user very likely would choose to click search result 202′ to get more details. In addition, the ZAGAT survey rating might help the user decide if the restaurant is as good as described by the restaurant review site, Citysearch, which is unknown to the user. In one embodiment the length of rating 214 is equal to or shorter than the length limit of the link with title 211. In another embodiment, the word count of rating 214 is less than or equal to the word count limit of abstract 212. The space allocated for displaying rating 214 provided by the third party should not be larger than the space allocated for displaying the search result 202, as shown in FIG. 2A.

Currently Internet users utilize search engines to search for many types of information. Users cannot be familiar with all subjects and all geographical areas. When users are presented with search results in areas and/or subjects not familiar to them, information provided by third parties trusted by the users would help users make decisions on which search results to view first and if the content of a particular search result with third-party rating (or evaluation) is trust-worthy or not. Third-party rating and/or evaluation can improve users' search experience. The ZAGAT survey is only one of the many examples of rating of services. Rating and evaluation have been provided by numerous sources to numerous products, services, and web sites. For example, Yahoo!®Movies provide information on movie ratings. A movie can get an “A”, “B”, “C”, “D”, “E” or “F” rating by the critics and by Yahoo! Users. Many other web sites or organizations also provide movie ratings, such as Rotten Tomatoes and The Classification and Rating Administration (CARA). Different users might trust different rating service providers more than others. Another example of rating is the rating of books, CD, and other products by Amazon users. Amazon™ compiles the user inputs and shows the ratings to other Amazon users. Advertisers for books or CDs sometimes quote the ratings of Amazon to promote books or CDs. Users who trust Amazon's ratings and reviews would find the search results more relevant and trust-worthy if Amazon ratings appear with the search results, when the users are searching for products that are rated and reviewed by Amazon. Yet another example of trusted third party rating is the rating by American Auto Association (AAA), which rates hotels, motels and other services. Many users rely on AAA rating to choose hotels and restaurants while traveling. Supplementing information of third party rating and/or review of trusted third parties by users in the search results would enhance the users' search experience.

Providing third-party rating (or evaluation) information in the search results helps users make decisions in which search results to view first and gives users better search experience. When users have better search experience with the search engine that provides such third-party rating information, users will like to use the search engine more and have more trust in the search engine. More users can be drawn to use search engine due to the better searching experience. As for the third parties that provide rating (or evaluation) information to the search engine (or system), providing rating information to be integrated with the search results can gain more recognition for the third parties. For example, when the user of FIG. 2D sees the ZAGAT survey rating in the search results, the user gains more recognition of ZAGAT survey. ZAGAT survey catches the user's eyeball when the user view the search result page 200′. In addition, the user could choose to know more about other ratings (or evaluations) or reviews conducted by ZAGAT survey and click on the image 231 of the rating provider, “ZAGAT”. When the image 231 is click, the browser can be taken to the ZAGAT survey web site, or a pop-up window with the ZAGAT survey web site can appear. The user might explore the ZAGAT survey web site for other information. When this happens, ZAGAT survey gains additional users to its web sites and gains more attention and recognition to the “ZAGAT” brand. Sometimes, some users know nothing about ZAGAT survey, and they would be exposed ZAGAT survey when the search system chooses to overlay ZAGAT survey rating in the search result as a default setting.

FIG. 2E shows a diagram of an information retrieval system 240 configured to provide third-party ratings in the information retrieved, in accordance with one embodiment of the present invention. The system 240 includes a client system 20, an Internet 30, a search server 50, a number of information server systems 40₁ to 40_{N}, and a number of rating information servers 280₁ to 280_{M} for providing third party ratings. Client system 20 is configured to communicate with the search server 50, and a number of information server systems 40₁ to 40_{N} and to request, access, receive, retrieve, and/or display a set of search results. As referred to herein a set includes one or more elements. The search system 50 is configured to communicate with the client system 20 to receive search quest and to return search results to the client system 20. In addition, search server 50 is configured to index contents in information server systems 40₁ to 40_{N}.

Additionally, rating information servers 280₁ to 280_{M} for providing third-party ratings are configured to send rating related information to search server 50 for search server 50 to integrate the rating related information from these third parties in the search results returned (or presented) to users. In one embodiment, the third party ratings are sent to a rating server 51, which can be part of search server 50 or can be separated from the search server 50. The rating server can have databases to store rating related information provided by the third parties. However, the rating server 51 is coupled to the search server 50 to allow data exchange between the search server 50 and the rating server 51. In one embodiment, the rating related information from third-party servers, 280₁ to 280_{M}, is sent to the rating server 51 through Internet. In another embodiment, the rating related information from third-party rating information servers, 280₁ to 280_{M}, is sent to the rating server 51 through designated communication lines, such as line 245. Third parties that provide rating information can also be associated with company that owns the search engine. For example, Yahoo! collects and provides rating information to various products and services, such as Yahoo! Movie rating. Yahoo! can provide third-party rating information to Yahoo!'s search engine. Since the movies being rated are not produced by Yahoo!, the rating is considered done by a third party.

The search server 50 along with the rating server 51 collect the rating related information from third-parties and manage the integration of the rating information with the search results. If there are more than one third parties that provide rating information to a product or service, which is called a collision of data, the search server (or search engine) 50 needs to have a way to manage the collision of data. In one embodiment, the search engine can give different weights to different rating information providers that are in the same categories. The rating information provided by the third party that has higher weight will be integrated in the search result, instead of the one with lower weight. For example, both ZAGAT survey and another rating provider Third Party X rate a particular restaurant Y. The search engine gives ZAGAT survey a higher weight. When a user's search results include restaurant Y, the rating information offered by ZAGAT survey is shown, instead of Third Party Z. Alternatively, the search engine can be configured to include rating information by more than one third party. Under such situation, rating information from both ZAGAT survey and Third Party X is included. However, each search result should only integrate (or overlay) rating information from limited number of third parties. If not, users can be confused or overwhelmed by search results with a number of ratings from different sources.

Integrating rating information in the search results takes computing resources from the search engine (or server) and can slow down the time it takes to return search results to the users. In one embodiment, only the first few pages of search results are integrated with the third-party rating information. In one embodiment, equal to or less than 1000 top results are integrated with the rating information. This means that the top 1000 results are checked with the database in the rating server to see if there is rating information available to be included with these 1000 top results. This does not mean all top 1000 results would be integrated with rating information. Only the top 1000 results with rating information available would be integrated with the rating information. In another embodiment, equal to or less than 100 top results are integrated with the rating information. In yet another embodiment, equal to or less than 25 or 10 top results are integrated with the rating information. In one embodiment, the number of search results integrated with rating information is set so that the search results are returned to the user within the time frame acceptable to most users (to avoid delay).

The number of search results that would be considered for overlay of third-party rating information, and the space and format of the overlay information presented to the user depend on the value of the third-party rating information added to the users. Internet search users expect search results being return in a reasonable amount of time, i.e. descent search returning performance. Internet search users also expect the search results being presented in formats that appeal to the users; therefore, the presentation of the third-party rating information must meet Internet users' expectation. In addition, Internet search users expect rating information that has a certain level of quality to make the information meaningful and useful to the users. Therefore, user expectation must be met in providing the third-party rating information.

The integration of search results with rating information should not significantly increase the time it takes to return the search results to a user. Since most users only view the top view returned pages of search results, integrating top search results with rating information would be acceptable to the majority of users. In one embodiment, the search system can allow users to request overlaying (or integrating) more search results with rating information. For example, there could be a “more overlay” button 250 on search page 200′ that allows users to choose to have overlays of rating information on higher number of search results. When a user makes such a selection, the user might be willing to wait for longer time for the integrated search results to appear.

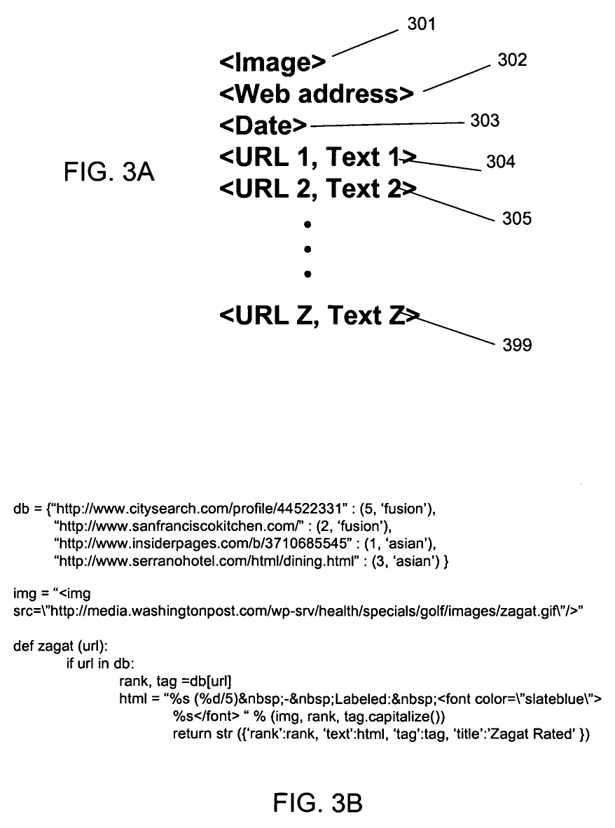

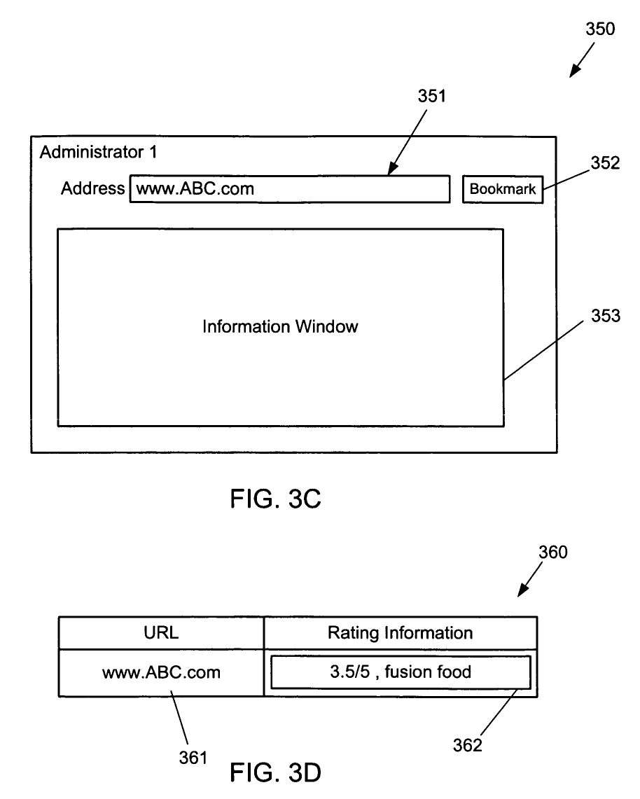

As mentioned above, the third parties that provide rating and evaluation services send rating related information to search server 50 or rating server 51 to be integrated and be presented with the search results. The rating related information can include the Uniform Resource Locators (URLs) of the companies, organizations, stores, or web sites, etc., that provide products and/or services being rated, the ratings, the URL of the third party web site, and the image representing the third party. FIG. 3 shows a list of information provided by a third party to the search server 50 or rating server 51, in accordance with one embodiment of the present invention. In the example shown in FIG. 3A, the third party provides an image representing the third party in code area 301. Borrowing the example of search result 202′ of FIG. 2D, the image described in the code area 301 is ‘ZAGAT’ in bold, as seen in image 231 of FIG. 2D. In addition, the third party provides web address of the third party in code area 302. In the example of search result 202′, the web address of ZAGAT survey is “www.zagat.com”. This address takes users to the ZAGAT survey web site, when users click on the image 231 of FIG. 2D. Optionally, the third party provides the date of the data provide in code area 303, which allows the third party and the administrator of search server 50 to know the date of the data. Most importantly, the third party provides a list of URLs of the products and services rated and description of the rating in code areas 304 to 399. In the example of search result 202′, the URL, such as URL, of code area 304, is the web address of “Teaz Me Fusion Café” or the address of a web page that describes “Teaz Me Fusion Café” in the event Teaz Me Fusion Café does not have a web site, or a web page on Citysearch. The text that goes along with the web address for Teaz Me Fusion Café, such as Text1 of code area 304, can include rating symbol, such as (5/5) of rating 232 in rating 214 of search result 202′, and other comments or description, such as brief description 233 in rating 214 of search result 202′, deemed relevant by the third party. The number of URLs and accompanying text can be high or low, depending on the number of products and services rated by the third party.

The data sent by the third party can be updated periodically by the third party. The third party can send the updated file to the search system, such as search server 50. Alternatively, the data can be sent through data feed by using data feed tools, such as Yahoo! Pipes or other methods.

The inserted third party rating, such as rating 214 of research result 202′ of FIG. 2D, can be generated statically or dynamically. When an insert is generated statically, (static insert), the insert is processed (or prepared) and saved before a user launches the search query. In contrast, when the insert is generated dynamically (dynamic insert), the insert is generated on the fly at the time the user enters the search query. One of the reasons to support dynamic insert is because some annotations (or inserts) may derive from additionally processing, dependent on the query. For example, if a user searches for ‘tennis racket’, which triggers an overlay from Amazon, the system could dynamically generate this annotation (or insert) by calling a function related to Amazon with two inputs: (1) the URL of the search result hitting Amazon's overlay, or (2) the search query. The function related to Amazon can return a better annotation knowing that the query is tennis racket, such as providing a user comment about tennis rackets. In addition, systems for dynamic inserts are easier to integrate, since it doesn't require the developers to have to have all the annotations (or inserts) preprocessed. If a developer makes one change, he/she may have to regenerate the annotations (or inserts) all over again for static inserts. However, for dynamic inserts using functions, the developer does not have to regenerate the annotations (inserts) all over again.

FIG. 3B shows a code for an application programming interface (API) to generate dynamic annotations (or inserts). The code defines a “zagat” function which takes a URL as an input and returns the insert annotation text. The function is mapped to the URLs of top search results (in parallel), for example top 100 results or top 20 results. This function performs a lookup in the database (“db= . . . ” line) to obtain the annotation fields, and then generates the piece of text with those fields as the final annotation text. The function will return an annotation for each URL that has a corresponding annotation fields in the database. The annotations generated are then displayed with the search results.

There is one more way of building annotations (or overlay inserts), which involves using a bookmarklet from a developer's or an administrator's browser. The bookmarklet is constructed by an API. The developer or the administrator is an employee of a third party that provides rating and/or review services on products and/or services. When the developer (or administrator) is on a page describing the product(s) or service(s) the developer's firm performs rating and/or review, the developer (or an administrator) can press “Save to Bookmarks” to save the URL of the page. This action will allow developer add URLs to the user's/developer's bookmarks. FIG. 3C shows a web page 350 being viewed by Administrator 1 of a third party that provides rating services, in accordance with one embodiment of the present invention. Administrator 1 is viewing a web page of a fictitious ABC company, with a URL “www.ABC.com”. The third party that the Administrator 1 works for has a rating for ABC company. On web page 350, there is an address area 351, which contains the web address of ABC company. There is also an information window 353 that describes the products and/or services provided by ABC company. Next to the address box 351, there is a “Bookmark” button 352, which when clicked would add the URL of the web page 350 to the Bookmarks of Administrator 1.

In one embodiment, when the developer or the administrator pushes the “Save to Bookmarks” button, a window appears to allow the developer or the administrator to enter rating related information, to the product or service described on the page being bookmarked. FIG. 3D shows a window 360 that appears with Administrator 1 pushes button 352, in accordance with one embodiment of the present invention. When window to 360 is opened, the URL of “www.ABC.com” is already entered by the bookmarklet. The bookmarklet in field 361. Next to field 361, there is a rating information box 362 that allows the Administrator to enter rating related information, such as 3.5/5 and fusion food, about the products and/or services described in the web page 350. In one embodiment the accumulated bookmarks with or without the accompanying rating is related information can be compiled by the API into a format ready to be sent to a search server or a rating server coupled to a search server.

Using a bookmarklet allows the developer or the administrator a simple way of accumulating a list of URLs with accompanying text that describes rating related information of the URL. There are tools and programs available for using API to generate a bookmarklet. For example, “del.icio.us” provides tools for making bookmarks.

Many search engines utilize various mechanisms, such as cookies, to track the users while users conduct searches. The search engines that track users during searches construct profiles of users based on the past search terms, search pages viewed, and other web usages accumulated by the companies that own the search engines. The mechanisms that are used to track users can also be utilized to customize overlay of third party rating for each user. Users can choose the third parties whose rating information they desire to receive or allow to be integrated with their search results. This customization allows users to filter out unwanted third-party ratings, and only allow the selected third-party ratings to be overlayed (or integrated) in their search results.

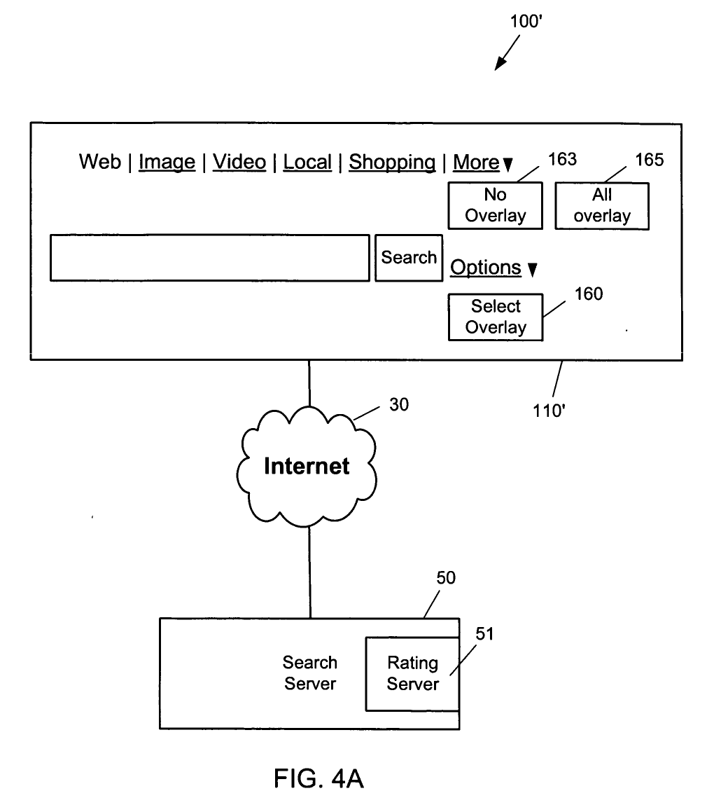

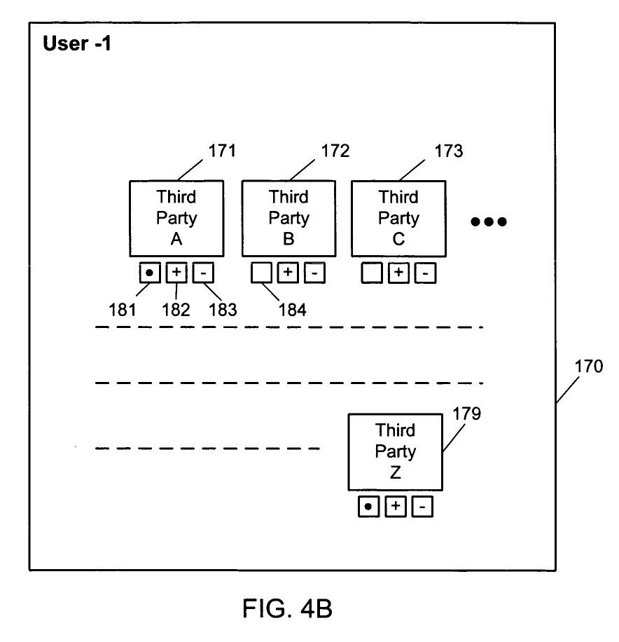

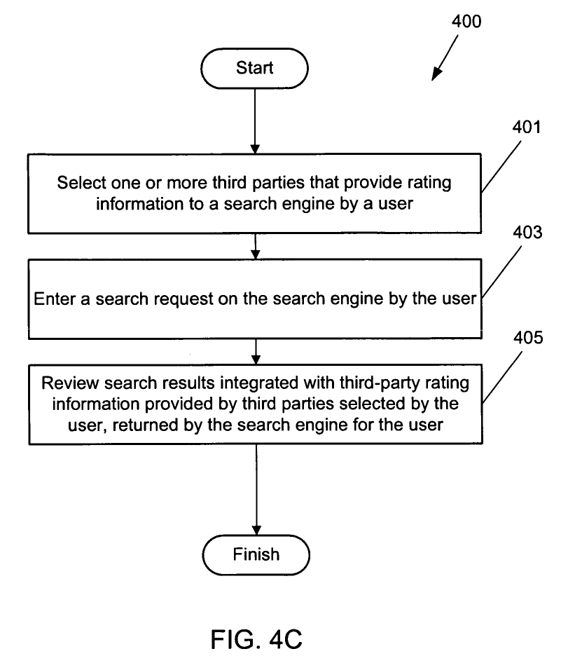

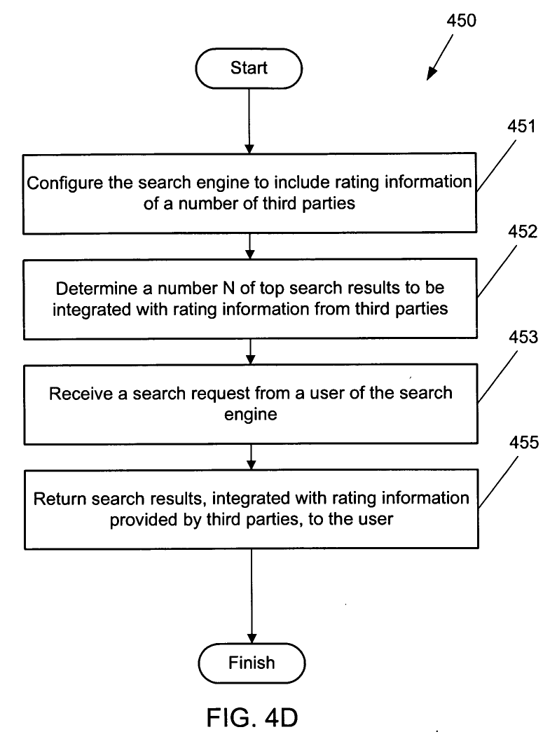

FIG. 4A shows a diagram illustrating a search system 100′ operating over the Internet 30 and a search window 110′ on a client computer of an USER-1, in accordance with one embodiment of the present invention. A search server 50 is also connected to the Internet 30 to interact with the search window 110′ of the user. A rating server 51 is inside the search server 50. The rating server 51 stores third-party rating information. The search window 110′ has an overlay selection button 160, which allows USER-1 to select third-parties that offer ratings to be integrated (or overlayed) with USER-1's search results. When USER-1 clicks on button 160, an overlay selection page 170, as shown in FIG. 4B, opens on USER-1's computer. The overlay selection page 170 has a number of overlay selections, such as Third Party A 171, Third Party B 172, Third Party C 173, to Third Party Z 179. Third Party A 171, Third Party B 172, Third Party C, 173, and Third Party Z 179 are third parties that offer rating services and also offered rating information to be integrated with search results. In each overlay selection, such as Third Party A 171, there is a status field, such as status field 181, signaling if the overlay has been selected. For example, the status field 181 of Third Party A 171 has a black dot, which signals that Third Party A 171 has been selected by USER-1. In another example, the status field 184 of overlay B 172 does not have a black dot, which signals that overlay B 172 has not been selected by USER-1. Next to status filed 181, there is a “select button” 182 for Third Party A 171. “Select button” 182 allows USER-1 to select Third Party A 171. Next to “select button” 182, there is a “de-select button” 183. When USER-1 clicks on the “de-select button” 183, Third Party A 171 is de-selected. By using overlay selection page 170, USER-1 can customize overlay of third party ratings with his/her search results.

FIG. 4C shows a process flow of a user conducting a search on a search engine, in accordance with one embodiment of the present invention. At step 401, a user selects one or more third parties that provide rating information to a search engine. The user can use the user interface, such as the one mentioned above, to make the selection. At step 403, the user enters a search request (by entering a search term) on the search box of the search engine. After the search engine receives the search term and checks with the user profile in terms of what third-party ratings being selected by the user, the search engine returns search results. At step 403, the user reviews the search results, which are integrated with third-party rating information provided by the selected third parties. This process gives users control of which third parties to be integrated in the users' search results.

Alternatively, the search engine can offer a default setting of allowing all overlay, or selected overlay, to be included in the search results. For example, FIG. 4A shows that there can be an “All Overlay” button 165 to search with overlay of all third-party rating information. In one embodiment, the third parties included have passed the screening criteria of the search engine and are allowed to provide information to the search engine. In addition, the users can search to have search results not integrated with third-party ratings. FIG. 4A shows that there can be a “No Overlay” button 163 to search without overlay of third-party rating information. Users can have control of what the users want to see in their search results.

FIG. 4D shows a process flow 450 of a search engine for integrating third-party rating information in the search results, in accordance with one embodiment of the present information. The third parties can be pre-screened by the administrator of the search engine to ensure the content is up to the standard set by the administrator. Alternatively, all third parties can be allowed to submit rating information without checking first. However, the administrators of the search engine can remove third parties that are sub-standard.

At step 451, a search engine is configured to include rating information of a number of third parties that offer rating information to be integrated with the search results. The third parties that provide rating information to the search engine are pre-selected by the administrators of the search engine, in one embodiment. At step 452, the search engine is configured to include rating information with a number of the top results. As discussed above, the number could be any integer number. For example, the number could be 1000, 100, 25 or 10. The number is set to not significantly affect the search return time. At step 453, the search engine receives a search request from a user. At step 455, the search engine returns search results that are integrated with third-party rating information. In one embodiment, the search engine check the user's profile to determine rating information from which third parties are allowed to be integrated with the search results of the user.

As mentioned above, third parties that offer ratings can benefit from offering rating information to search engines. The benefit includes, but not limited to, gaining recognitions from users using search engines. As mentioned above, users can click on the images, such as image 231 of FIG. 2D, of the third parties to get to the web sites of the third parties. Some third parties are not configured with a search engine to search results on their web sites. Companies that own the search engines can offer search boxes on the web sites of the third parties. The search boxes offered by the search engines can direct the search queries to the search engines with the overlay of the third party where the users launch the search. For example, Yahoo! Search can offer search engine box at a third party web site, such as ZAGAT survey. When a user visits a ZAGAT survey web site and enters a search term in the search box generated by the code offered by Yahoo! Search, the search term (or search query) is directed to Yahoo! Search engine and the search results are overlayed with ratings by ZAGAT survey.

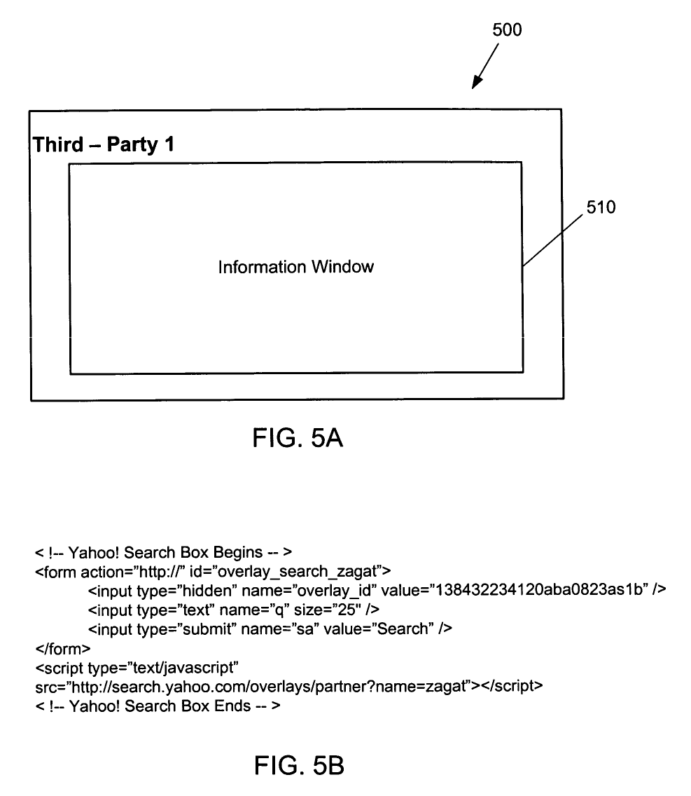

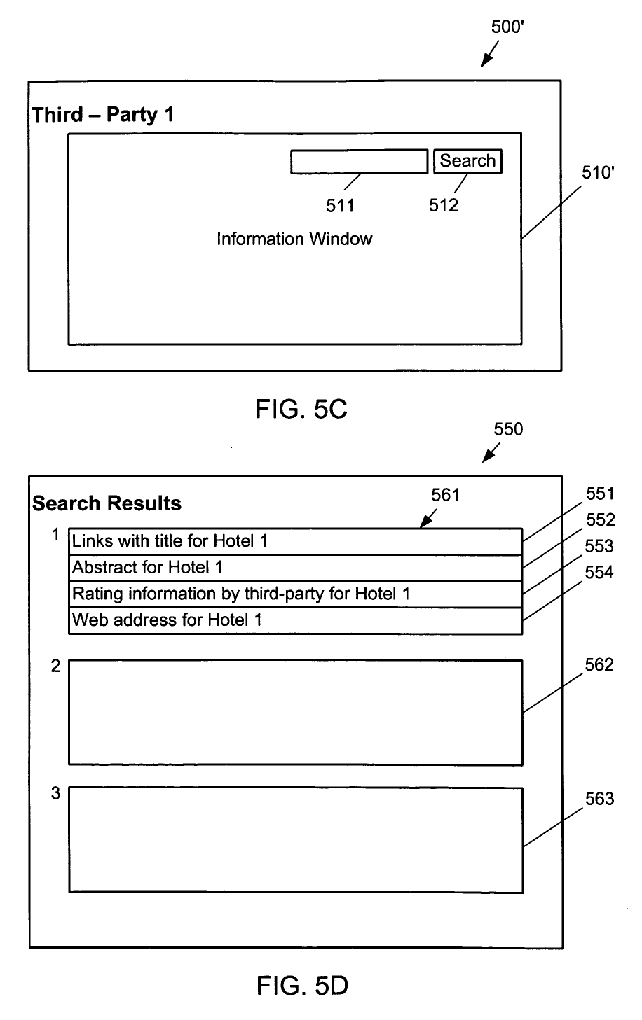

FIG. 5A shows an exemplary web page 500 of Third-Party 1, such as ZAGAT survey, that offers rating services. Web page 500 includes an information window 510. FIG. 5B shows the exemplary code that a search engine, such as Yahoo! Search, offers to the Third-Party 1 to include in the web page code to create a search box. FIG. 5C show a web page 500′ of Third-Party 1 with an information window 510′. In information window 510′, there is an additional search box 511 and search button 512. When a user enters a search string (or term), such as “hotel in Park City, Utah”, and pushes the search button 512, the search query will be directed to Yahoo! Search to find relevant results. The search results returned will be integrated with the rating offered by Third-Party 1. FIG. 5D shows a search result page 550 for the user that enters “Hotel in Park City, Utah”, in accordance with one embodiment of the present invention. In the search results, there are a number of research results, such as results 561, 562, and 563. Search result 561 includes a link with title 551 for Hotel 1, an abstract 552 for the web site of Hotel 1, a rating 553 by Third-Party 1 for Hotel 1, and a web address 554 for Hotel 1 web site. Results 562 and 563 may or may not have ratings from Third-Party 1. The search box 511, in FIG. 5C and offered by the search company, provides users of web site of Third-Party 1 access to a search tool and the research results integrated with ratings from Third-Party 1.

Third party ratings give users additional information on the search results and help users decide whether to click on the search results with the additional third party rating information. Third parties that offer rating services can also gain more name recognition by providing rating information to the search engine. In one embodiment, the search engine can offer rewards, such as money, to third parties that provide information to be integrated with the search engine. In another embodiment, third parties that provides ratings offers incentives, such as money, to search engines for integrating their ratings (or reviews) in the search results. Third parties offer incentives to the search engines (or companies that own the search engines) for displaying their ratings with the search results because the third parties would gain more recognition from users.

The concept of this invention can be applied to any search engines and any third party that offers rating (or review) services. In addition, the concept can be applied to any information provided by third parties. Information provided by third parties to be integrated is not limited to rating information. Reviews or comments can also be included. With the above embodiments in mind, it should be understood that the invention might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium may also include an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method of returning search results overlayed with third-party rating information by a search engine, comprising:
configuring the search engine to include rating information provided by a plurality of third parties to be integrated with the search results;
receiving a search request from a user; and
returning search results related to the search request, wherein the search results are overlayed with rating information relevant to the search results and the rating information being provided by the plurality of third parties, and wherein the rating information being overlayed provides the user additional information about the search results to assist the user determine the relevancy of the search results.

2. The method of claim 1, further comprising:
determining an N number of top search results that would be integrated with the rating information, wherein the N number is an integer number, wherein only the N number of top search results are overlayed with the rating information provided by the plurality of third parties,

3. The method of claim 1, further comprising:
checking a profile of the user for third parties selected by the user to overlay the search results with rating information provided by the selected third parties after receiving the search request from the user.

4. The method of claim 2, wherein the number N is selected to be the largest number that does not affect significantly affect a time that takes to return the search results to the user.

5. The method of claim 2, wherein the number N is equal to or less than 100.

6. The method of claim 1, wherein the rating information includes an image of one of the plurality of third parties that provides the rating information, and wherein the image, when clicked, is hyper-linked to a web page of the one of the plurality of third parties that provides.

7. The method of claim 1, wherein the rating information overlayed in the search results has a word count equal to or less than a word count limit for an abstract of the search results.

8. The method of claim 1, wherein the rating information overlayed in the search results has a length equal to or less than a length limit for a link with title of the search results.

9. The method of claim 1, wherein the rating information is displayed below a link with title and an abstract of one of the returned search results.

10. The method of claim 1, wherein the search engine assigns different weights to the plurality of third parties to assist in determining rating information from which of the plurality of third parties to include in the search results when more than one rating information for a search result become available.

11. The method of claim 1, wherein configuring the search engine to include rating information provided by a plurality of third parties include receiving rating information files from the plurality of third parties, and wherein each of the rating information files contains a list of Uniform Resource Locators (URLs) with corresponding rating-related texts.

12. The method of claim 11, wherein the list of URLs is collected by an API installed on a computer of an administrator of a third party of the plurality of third parties.

13. An information retrieval system for searching information stored on a plurality of information server systems connected to the Internet and to return search results with integrated rating information, comprising:
the plurality of information server systems storing information to be retrieved by users, wherein the information servers are connected to the Internet;
a search system, wherein the search system is connected to the Internet and indexes content on the plurality of information server systems, and wherein the search system receives a search request from a user and returns the search results related to the search request to the user; and
a third-party rating server system connected to the Internet, wherein the third-party rating server system provide rating information on some of the information stored on the plurality of information server systems, the rating information being provided to the search system and the rating information being integrated in the search results presented to the user to provide the user additional information about the search results.

14. The information retrieval system of claim 13, further comprising:
a rating server, wherein the rating server is coupled to the search system and stores the rating information provided by the third-party rating server system.

15. The information retrieval system of claim 13, wherein the information stored on the plurality of information servers includes web pages, videos, audios, images, and databases.

16. The information retrieval system of claim 13, wherein the search system assigns different weights to the third-party rating server system to assist in determining which rating information from the third-party rating server system to include in the search results when more than one rating information for a search result becomes available.

17. The information retrieval system of claim 13, wherein the search system establishes a profile of the user regarding which rating information to include for the user, and wherein the user provides information to the search system to establish the profile.

18. The information retrieval system of claim 13, wherein the rating information is integrated with equal to or less than top 100 search results.

19. Computer readable media including program instructions for returning search results overlayed with third-party rating information by a search engine, comprising:
program instructions for configuring the search engine to include rating information provided by a plurality of third parties to be integrated with the search results;
program instructions for receiving a search request from a user; and
program instructions for returning search results related to the search request, wherein the search results are overlayed with rating information relevant to the search results and the rating information being provided by the plurality of third parties, and wherein the rating information being overlayed provides the user additional information about the search results to help the user determine the relevancy of the search results.

20. The computer readable media of claim 19, further comprising:
program instructions for determining an N number of top search results that would be integrated with the rating information, wherein the N number is an integer number, wherein only the N number of top search results are overlayed with the rating information provided by the plurality of third parties,

21. The computer readable media of claim 19, further comprising:
program instructions for checking a profile of the user for third parties selected by the user to overlay the search results with rating information provided by the selected third parties after receiving the search request from the user.

22. The computer readable media of claim 21, wherein the profile of the user is established by the user before the user initiates the search request, the profile being established by selecting a number of the plurality of third parties to allow rating information of the number of the plurality of third parties to be integrated with the user's search results.

23. The computer readable media of claim 20, wherein the number N is selected to be the largest number that does not affect significantly affect a time that takes to return the search results to the user.

24. An information retrieval system for searching information stored on a plurality of information server systems connected to the Internet and to return search results with integrated overlay information, comprising:
the plurality of information server systems storing information to be retrieved by users, wherein the information servers are connected to the Internet;
a search system, wherein the search system is connected to the Internet and indexes content on the plurality of information server systems, and wherein the search system receives a search request from a user and returns the search results related to the search request to the user; and
a third-party overlay server system connected to the Internet, wherein the third-party overlay server system provide overlay information on some of the information stored on the plurality of information server systems, the overlay information being provided to the search system and the overlay information being integrated in the search results presented to the user to provide the user additional information about the search results.

25. The information retrieval system of claim 24, further comprising:
a rating server, wherein the overlay server is coupled to the search system and stores the overlay information provided by the third-party rating server system.
